(19) United States
(12) Patent Application Publication
(10) Pub. No.: US 2015/0057495 A1
(43) Pub. Date: Feb. 26, 2015

(54) Safe Uni-Sex-Organ Insertion Membrane Sponge Assembly

(71) Applicant: Timothy Bernard Wilks, Waupun, WI (US)

(72) Inventor: Timothy Bernard Wilks, Waupun, WI (US)

(21) Appl. No.: 13/971,821

(22) Filed: Aug. 20, 2013

(51) Int. Cl. A61H 19/00

(52) U.S. Cl. CPC A61H 19/50; A61H 19/44; A61H 19/32
USPC 600/41; 600/38

(57) ABSTRACT

The uni-sex-organ insertion membrane sponge assembly is basically embodied in a soft resilient flexible latex figured material which integrally forms an elongated penis-vagina organ impressionable channel encompassment, being continuous into each: a sponge ball impressionable bulged closed end portion; a funnel mouth entry-exit orifice area; a sponge pad impressionable bulged hem rim portion; and, a seam bonded open-end portion. The sex-organ insertion membrane sponge assembly may also include an alternative improvement assembly means whereby an incorporated soft resilient flexible latex figured material integrally forms a triangular coccyx shaped convergence joint, being continuous into three seperately diverging strap extensions, which affixably overlap three equi-distantly spaced sections of said bulged hem rim portion and terminate at said seam bonded open-end portion, so that one said strap may connectably extend along between human buttocks, and so that two said straps may connectably extend along around human hip-thigh joints.

### BACKGROUND OF THE INVENTION

1. Field of the Invention

The present invention relates to sexual intercourse devices and methods used for safety protection against sexually transmittable diseases and/or child birth conception from genital fluids.

2. Description of the Prior Art

Heretofore, old and current contemporary sexual intercourse safety devices and methods are limited in efficiency and effectiveness during their employment for safe sex protection.

One most common but vulnerable safety device used for protection against both sexually diseased and birth conceptionable genital fluids is a rubber sheathe article generally identified by the name condom and worn soley by a male over his penis genitalia during sexual intercourse. To the contrary, any given random condom is still always susceptible to random exposures of sexually diseased or birth conceptionable genital fluids due to either unpredictable condom motion friction roll-off or punctured condom sheathe seeps during sexual intercourse. As of yet, such random condom exposure deficiencies have not been sufficiently decreased as they may be. Another deficiency drawback to the typical condom is that it only may be worn and employed by a male of whom a female must rely on for its safe sex protection.

Another, albeit not as common safe sex device is a dome-shaped rubber diaphragm designed for insertion into a female's vagina to cover her cervix and prevent birth conception with a male's genital fluids. However, although the diaphragm device may successfully prevent transmission of a male's birth conceptionable genital fluids into the cervix of a female, it is still deficient in safe sex effectiveness. For instance. Although the diaphragm device does effectively cover the cervix from a male's birth conceptionable genital fluids, it would still leave the rest of a female's vagina genitalia exposed to a male's sexually diseased genital fluids because it does not cover the entire vagina wall area. Moreover, it is inconveniently necessary to leave the diaphragm device in place against the cervix for up to six hours for the most efficiency in effective birth control practice, after sexual intercourse.

Another former common contraceptive device called (IUD's) Intrauterine Devices are formed of either spiral or looped plastic or metal pieces mechanically placed inside a female's uterus to prevent ovulation reception. It also has drawbacks such as: physical discomforts; physiological side effects; accidental displacement; and, costly and invasive professional medical insertion services for fittings and re-examinations.

As for a very commonly used pill birth control method, although it is most efficient in preventing ovulation, it still poses many very serious risk such as changes in body metabolisms, physiological side effects, and increased aggrevations to outstanding health concerns. Moreover, the medically required prescription necessary for the availability of birth control pills could at times of hardship or random forgetfulness delay and/or inconvenience the timely necessity for availability and access to the pill.

Other possible birth control methods such as sterilization by tying or severing male or female reproductive organs are available permanent optional alternatives but are rarely used due to their irreversible permanency and may be never preferred in light of a more effective new but less permanent method.

### SUMMARY OF THE INVENTION

It is an object of this invention to provide a newly advanced uni-sex-organ genitalia insertion membrane sponge assembly with a crotch and pelvis joined strap attachment for alternative male or female gender wear and safety protection against opposite gender transmissions of either sexually diseased or birth conceptionable genital fluids during sexual intercourse.

The advanced genitalia insertion membrane sponge assembly has numerous safe sex advantages in employment as well as effectiveness and efficiency. One of it's principal advantages is that the genitalia insertion membrane is facilitated with a crotch and pelvis joined strap so that whenever it is worn by either a male or female for self responsible safe sex protection, it can neither be advertently or inadvertently unstrapped or displaced from the wearers pelvis and/or crotch genitalia without the wearers notice. This advantage is unlike where as in the case of the heretofore typical contemporary condom, a otherwise self responsible safe sex female must rely on a male's use of a non-female condom and be susceptible to randomly having the male condom advertently or inadvertently displaced from his penis genitalia without her ever noticing.

In addition to the safe sex protection advantages of said crotch and pelvis joined strap, the gentalia insertion membrane is also facilitated with two advantageous sponge puff pieces for effective safety retention and positioning of a genitalia insertion membrane sheathe inside and outside the vagina genitalia during sexual intercourse. For instance, the pre-facilitated insertion of a fully expanded sponge puff ball against the inside closed-end tip of a genitalia insertion membrane, would allow the fully expanded sponge puff ball's tip area outside the genitalia insertion membrane to be retained from retraction by the vagina's wall's friction-contraction and vacuum-suction at the cervix neck area so that upon the perpetual withdrawal motions of the penis, the genitalia insertion membrane sheathe will not also be withdrawn from the vagina with the withdrawal motions of the actual penis. Furthermore, the pre-facilitated insertion of a fully expanded hollow sponge puff pad looped within an extended overlapped folded orifice end of the genitalia insertion membrane, would prevent the orificed open-end edge of the genitalia insertion membrane from being possibly dragged and trapped inside the vagina upon the perpetual insertion motion of the penis, and therefore from being inadvertently rolled off the penis by friction from the vagina's wall. This advantage is unlike where as in the case of the heretofore typical contemporary condom, it's unstable open-end edge allows for random chance of condom drag into the vagina and/or friction roll-off from the penis.

There is also other beneficial safety effectiveness and efficiency advantages to implanting sponge puff pieces in said inside tip and outside orifice of the genitalia insertion membrane. For instance. The sponge puff ball implanted at the inside tip of the genitalia insertion membrane is pre-treated with a liquid solvent spermicide which is not only intended to maximize its expanse volume at the inside tip for the outside vagina wall's maximum contraction and suction retention of the membrane from inadvertent withdrawal, but also to absorb and to spermicidally destroy any penis seminal fluid secretions that might otherwise seep through punctured membrane holes into the vagina. Additionally, the sponge puff pad looped within the orificed open-end of the genitalia insertion membrane acts as an absorbent buffer between the pelvis of opposite genders during sexual intercourse to minimize perpetual insertion compression discomfort; and, act as a safe sex male masterbation hand grip catch to prevent the open-end of an interior oil-lubricated insertion membrane from roll-off or hand-grip slippage during perpetual masterbation stroking, as well as to catch and prevent unmessy ejaculation semen spillage.

### BRIEF DESCRIPTION OF THE DRAWINGS

The present safe uni-sex-organ insertion membrane invention will be more fully understood by reference to the below annexed figure drawings and following detailed description for comparative mechanical analysis.

FIG. 1 is a plain side part sectional view of the genitalia insertion membrane sponge assembly.

FIG. 2 is the sectional plane part view of FIG. 1's genitalia insertion membrane sponge assembly.

FIG. 3 is a perspective view of FIG. 1's genitalia insertion membrane sponge assembly incorporating a strap attachment to illustrate its position of employment by a female's vagina, crotch, and pelvis.

FIG. 4 is a perspective view of FIG. 1's genitalia insertion membrane sponge assembly incorporating a strap attachment to illustrate its position of employment by a male's penis, crotch, and pelvis.

### DETAILED DESCRIPTION OF THE DRAWINGS

The uni-sex-organ insertion membrane sponge assembly, comprises:

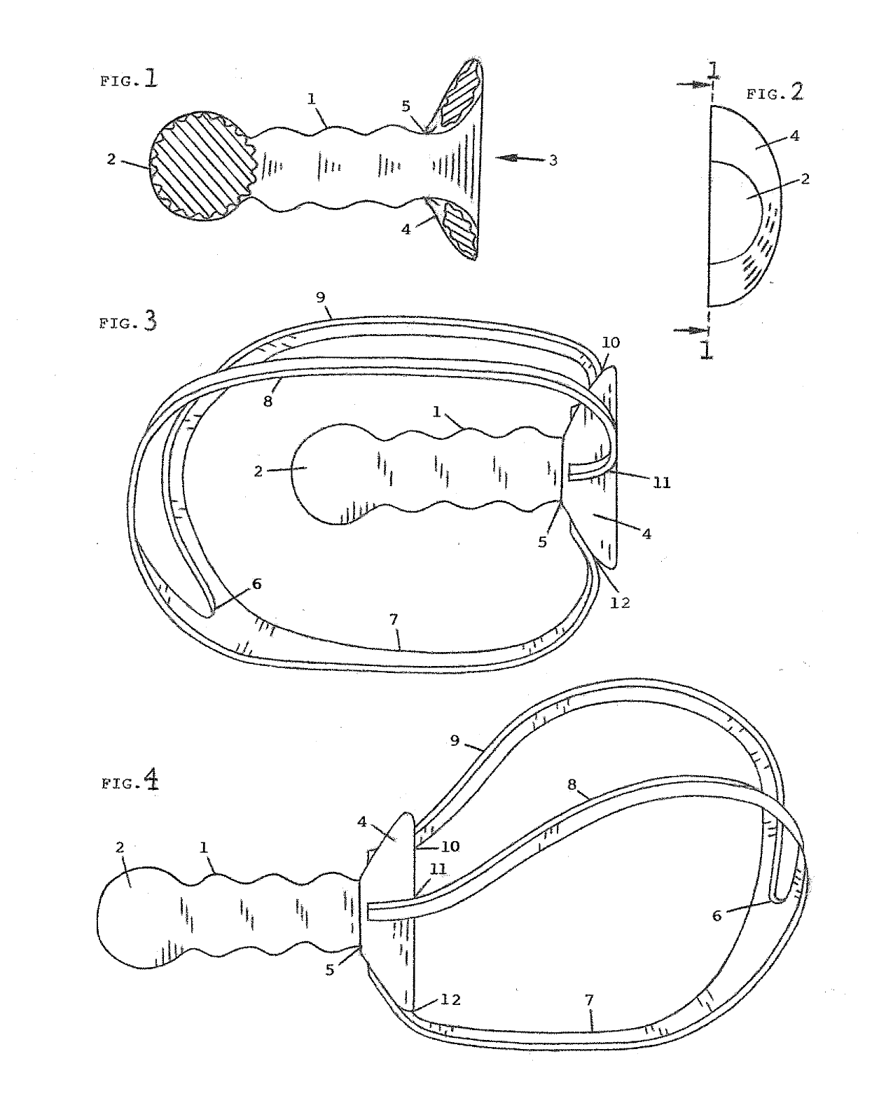

FIGS. 1, 2, 3, and 4 as shown depict, a soft resilient flexible latex figured material which integrally forms: an elongated penis-vagina organ impressionable channel encompassment 1, being continuous into each: a sponge ball impressionable bulged closed end portion 2; a funnel mouth entry-exit orifice area 3; a sponge pad impressionable bulged hem rim portion 4; and, a seam bonded open-end portion 5.

FIGS. 3 and 4 as shown depict, a incorporated soft resilient flexible latex figured material which integrally forms: a triangular coccyx shaped convergence joint 6, being continuous into three seperately diverging strap extensions 7, 8, and 9 which affixably overlap three equidistantly spaced sections 10, 11, and 12 of said bulged hem rim portion 4 and terminate at said seam bonded open-end portion 5 so that one said strap 7 may connectably extend along between human buttocks and so that two said straps 8 and 9 may connectably extend along around human hip-thigh joints.

I claim:

1. A soft resilient flexible latex figured material which integrally forms an elongated penis-vagina organ impressionable channel encompassment—being continuous into each: a sponge ball impressionable bulged closed end portion—a funnel mouth entry-exit orifice area—a sponge pad impressionable bulged hem rim portion—and, a seam bonded open-end portion.

2. Claim 1 wherein, a incorporated soft resilient flexible latex figured material integrally forms a triangular coccyx shaped convergence joint—being continuous into three seperately diverging strap extensions—which affixably: overlap three equidistantly spaced sections—of said sponge pad impressionable bulged hem rim portion—and; terminate at said seam bonded open-end portion—so that one said strap may connectably extend along between human buttocks—and, so that two said straps may connectably extend along around human hip-thigh joints.
